(19) United States
(12) Patent Application Publication
(10) Pub. No.: US 2022/0129084 A1
(43) Pub. Date: Apr. 28, 2022

(54) DISPLAY DEVICE AND DISPLAY CONTROL PROGRAM

(71) Applicant: KYOCERA Document Solutions Inc., Osaka (JP)

(72) Inventor: Kohei KONISHI, Osaka (JP)

(73) Assignee: KYOCERA Document Solutions Inc., Osaka (JP)

(21) Appl. No.: 17/429,797

(22) PCT Filed: Jan. 21, 2021
(86) PCT No.: PCT/JP2020/001820

§ 371 Date: Aug. 10, 2021

(30) Foreign Application Priority Data
Feb. 13, 2019 (JP) 2019-023901

(51) Int. Cl. G06F 3/023; G06F 3/04886

(52) U.S. Cl. CPC G06F 3/023; G06F 3/04886

(57) ABSTRACT

A mobile terminal device (10) includes a display unit (11), a controller (21) that displays an input field and a software keyboard on a screen of the display unit (11), a touch panel (12) that receives an input of a character string including character, symbol, or code to the input field, according to an operation of a user performed on the software keyboard, and a decider (22) that decides whether the character string inputted to the input field through the touch panel (12) satisfies a predetermined condition. The controller (21) sets the software keyboard undisplayed in the screen of the display unit (11), when the decider (22) decides that the predetermined condition is satisfied.

### TECHNICAL FIELD

The present invention relates to a display device and a display control program, and in particular to a technique to display a software keyboard on a screen of a display unit.

### BACKGROUND ART

Existing display devices are configured to display a software keyboard on a screen of a display unit, instead of a hardware keyboard. A touch operation on a key of the software keyboard is detected through a touch panel provided on the screen of the display unit, and the character, symbol, or code associated with the touched key is inputted. The software keyboard is displayed or undisplayed depending on, for example, whether an input field in the screen of the display unit is focused.

In addition, an image processing device according to Patent Literature (PTL) 1 is configured to restrict the display of the software keyboard, under a specific condition that requires the software keyboard to remain undisplayed, because frequent alternation of the displayed state and the undisplayed state of the software keyboard is troublesome. For example, when a hardware keyboard is connected to the image processing device, the display of the software keyboard is restricted.

### CITATION LIST

### Patent Literature

PTL 1: Japanese Unexamined Patent Application Publication No. 2005-346179

### SUMMARY OF INVENTION

### Technical Problem

Under the mentioned arrangement, that the software keyboard is displayed or set undisplayed depending on whether the input field in the screen of the display unit is focused, the displayed state and the undisplayed state of the software keyboard are frequently alternated. In addition, the arrangement according to PTL 1 merely restricts the display of the software keyboard, when the hardware keyboard is connected to the apparatus, and is not designed to properly switch between the displayed and undisplayed states of the software keyboard, during the use thereof, from the viewpoint of improving the user friendliness of the device.

The present invention has been accomplished in view of the foregoing situation, and provides a technique to set the software keyboard displayed or undisplayed, at a proper timing so as to improve the user friendliness of the device.

### Solution to Problem

In an aspect, the present invention provides a display device including a display unit, a controller that displays an input field and a software keyboard on a screen of the display unit, an input device that receives an input of a character string including characters, symbols, or codes to the input field, according to an operation performed by a user on the software keyboard, and a decider that decides whether the character string inputted to the input field through the input device satisfies a predetermined condition. The controller sets the software keyboard undisplayed in the screen of the display unit, when the decider decides that the predetermined condition is satisfied.

In another aspect, the present invention provides a display control program configured to cause a computer to act as a controller that displays an input field and a software keyboard on a screen of a display unit, an input device that receives an input of a character string including characters, symbols, or codes to the input field, according to an operation performed by a user on the software keyboard, and a decider that decides whether the character string inputted to the input field through the input device satisfies a predetermined condition, and to cause the computer to cause the controller to set the software keyboard undisplayed in the screen of the display unit, when the decider decides that the predetermined condition is satisfied.

### Advantageous Effects of Invention

The arrangement according to the present invention enables the software keyboard to be displayed or undisplayed, at a proper timing so as to improve the user friendliness of the device.

### BRIEF DESCRIPTION OF DRAWINGS

FIG. 1 is a plan view showing the appearance of a mobile terminal device incorporated with a display device according to an embodiment of the present invention.

FIG. 2 is a block diagram showing an internal configuration of the mobile terminal device according to the embodiment.

FIG. 3 is a flowchart showing a process to select whether to display or not to display a software keyboard.

FIG. 4A is a schematic drawing showing a window including two input fields shown in a screen of the display unit.

FIG. 4B is a schematic drawing showing a state where a blank portion in the input field in the screen of the display unit has been touched.

FIG. 4C is a schematic drawing showing the software keyboard additionally displayed in the screen of the display unit.

FIG. 5A is a schematic drawing showing an example of conditions to be satisfied by a character string in the input field in the screen of the display unit.

FIG. 5B is a schematic drawing showing another example of the conditions to be satisfied by the character string in the input field.

FIG. 5C is a schematic drawing showing another example of the conditions to be satisfied by the character string in the input field.

FIG. 6 is a schematic drawing showing a state where a non-display region, in which no characters, symbols, or codes are to be displayed, except for the input field in the screen of the display unit, has been touched.

FIG. 7A is a schematic drawing showing a touched position on the character string, in the input field in the screen of the display unit.

FIG. 7B is a schematic drawing showing a cursor displayed at the position of FIG. 7A in the input field.

FIG. 8A is a schematic drawing showing a state where a character string, displayed in a region different from the input field in the screen of the display unit, has been touched.

FIG. 8B is a schematic drawing showing a state where the character string touched in FIG. 8A is displayed in the input field.

### DESCRIPTION OF EMBODIMENT

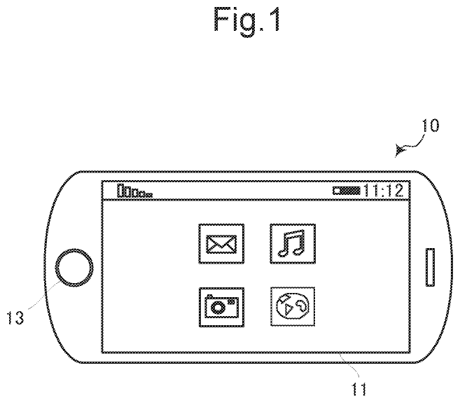

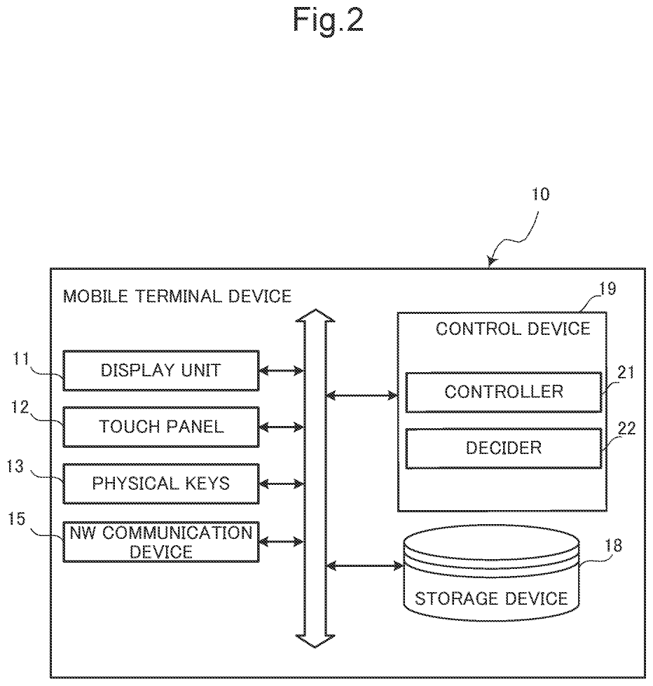

Hereafter, an embodiment of the present invention will be described, with reference to the drawings. FIG. 1 is a plan view showing the appearance of a mobile terminal device incorporated with a display device according to an embodiment of the present invention. FIG. 2 is a block diagram showing an internal configuration of the mobile terminal device according to the embodiment.

The mobile terminal device 10 according to this embodiment is, for example, a smartphone or a mobile computer, and includes a display unit 11, a touch panel 12, physical keys 13, a network (NW) communication device 15, a storage device 18, and a control device 19. These components are configured to transmit or receive data and signals to and from each other, through a bus.

The display unit 11 is, for example, constituted of a liquid crystal display (LCD) or an organic light-emitting diode (OLED) display. For example, a plurality of icons are displayed on the screen of the display unit 11.

The touch panel 12 is based on a resistive film or electrostatic capacitance. The touch panel 12 is overlaid on the screen of the display unit 11, and configured to detect a contact (touch) of the user's finger, along with the touched position, and to input an instruction of the user to the screen of the display unit 11. Accordingly, the touch panel 12 serves as an operation device for receiving the instruction of the user inputted through the screen of the display unit 11. The touch panel 12 exemplifies the input device in the present invention.

The mobile terminal device 10 also includes physical keys 13, in addition to the touch panel 12, as the operation device through which the user's operation is inputted.

The NW communication device 15 is a communication interface having a communication module such as a non-illustrated LAN chip. The NW communication device 15 is connected to a terminal device such as an external server, through the LAN or the internet.

The storage device 18 includes storage devices such as a random-access memory (RAM) and a hard disk drive (HDD), and contains various application programs and various types of information.

The control device 19 includes a processor, a random-access memory (RAM), a read-only memory (ROM), and so forth. The processor is, for example, a central processing unit (CPU), an application specific integrated circuit (ASIC), or a micro processing unit (MPU). The control device 19 acts as a controller 21 and a decider 22, when the processor executes a control program stored in the ROM or the storage device 18.

The control device 19 is connected to the display unit 11, the touch panel 12, the physical keys 13, the NW communication device 15, and the storage device 18. The controller 21 controls the operation of the cited components, and also transmits and receives signals or data, to and from these components.

The controller 21 also acts as a processing device that performs various types of processings. Further, the controller 21 controls the displaying operation of the display unit 11, and the communicating operation of the NW communication device 15.

The decider 22 decides whether a character string, inputted through the touch panel 12 to an input field, displayed on the display unit 11 under the control of the controller 21, satisfies a predetermined condition.

With the mobile terminal device 10 configured as above, when the user touches the blank portion in the input field, displayed in the screen of the display unit 11 under the control of the controller 21, the controller 21 detects, through the touch panel 12, the touch operation performed on the blank portion in the input field, and causes the display unit 11 to display a software keyboard on the screen thereof, according to the detection.

In addition, when the user touches a key of the software keyboard, while the software keyboard is displayed in the screen of the display unit 11, the controller 21 detects such touch operation through the touch panel 12, and when an input of a character, symbol, or code corresponding to the touched key is received by the touch panel 12, the controller displays the character, symbol, or code that has been received, in the input field.

Each time the key of the software keyboard is touched, the controller 21 detects the touch operation on that key, through the touch panel 12, and displays, each time the input of the character, symbol, or code associated with the touched key is sequentially received by the touch panel 12, the sequentially received character, symbol, or code in the input field. At this point, the decider 22 decides whether the character string composed of the character, symbol, or code displayed in the input field satisfies the predetermined condition. When the decider 22 decides that the predetermined condition is satisfied, the controller 21 sets the software keyboard undisplayed, in the screen of the display unit 11.

Examples of the predetermined condition include: (1) that the character, symbol, or code located at the tail end, or along a plurality of positions from the tail end, of the character string in the input field, accords with one of predetermined characters, symbols, or codes included in address information on the internet and indicating the tail end of the address information, such as “.com”, and “.co.jp”; (2) that the code at the tail end of the character string in the input field is a punctuation mark such as “.”; and (3) that the number of characters, symbols, or codes in the character string in the input field has reached a predetermined limiting number N. The limiting number N serves to limit the number of characters, symbols, or codes indicating, for example, the ID information and the password of the user. The mentioned conditions are stored in advance in the storage device 18, for example by the controller 21.

In the case where a plurality of input fields are displayed in the screen of the display unit 11, the controller 21 erases (sets to be undisplayed) the software keyboard.

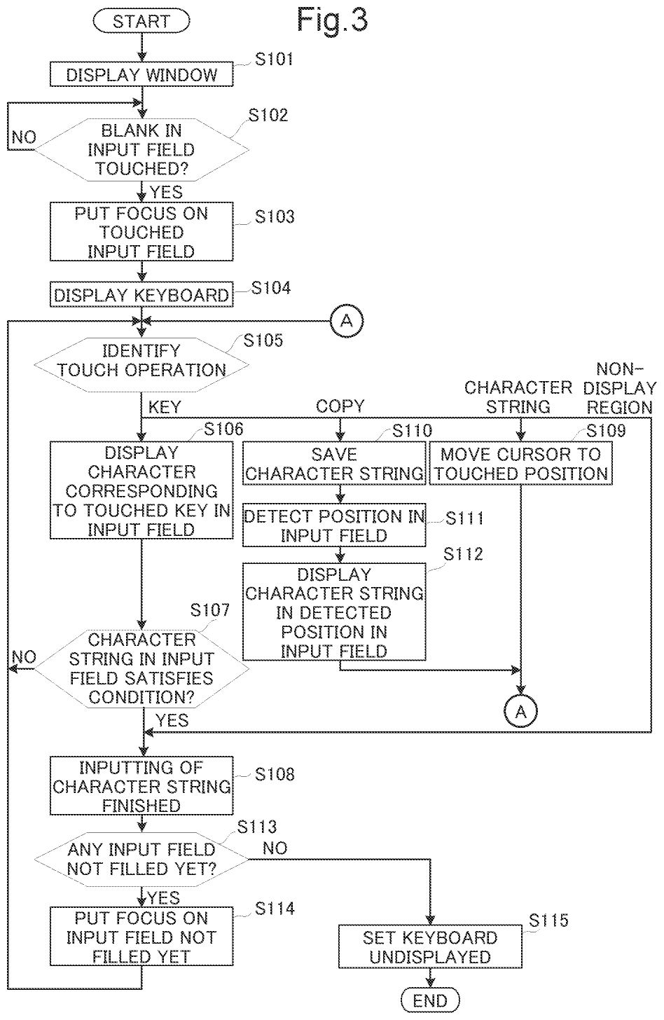

Referring to the flowchart shown in FIG. 3, the process of displaying and erasing the software keyboard will be described hereunder.

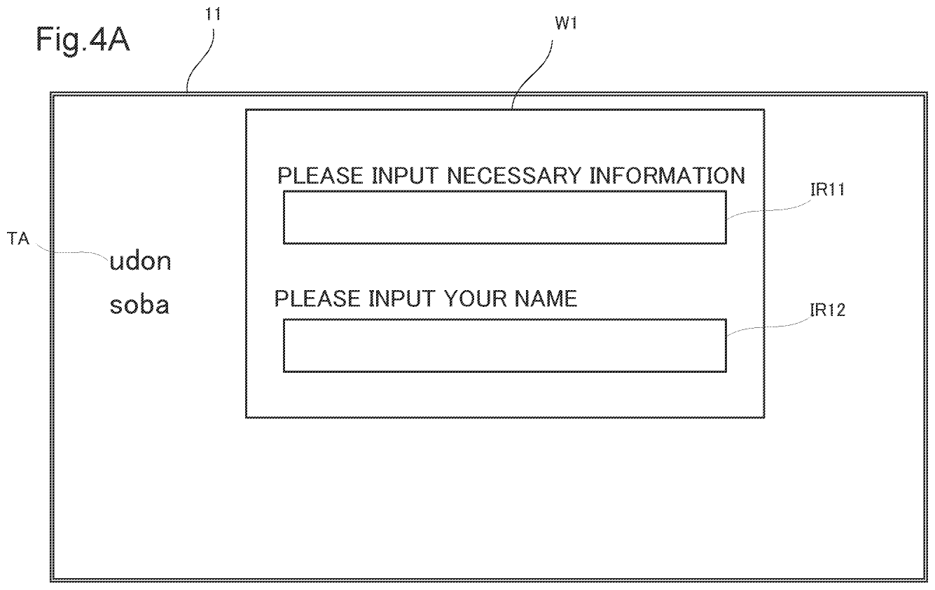

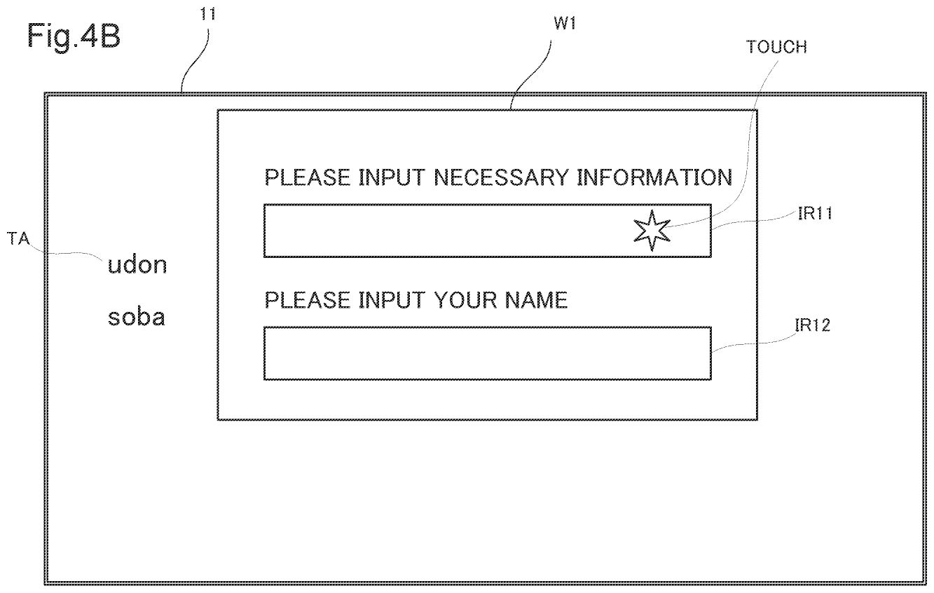

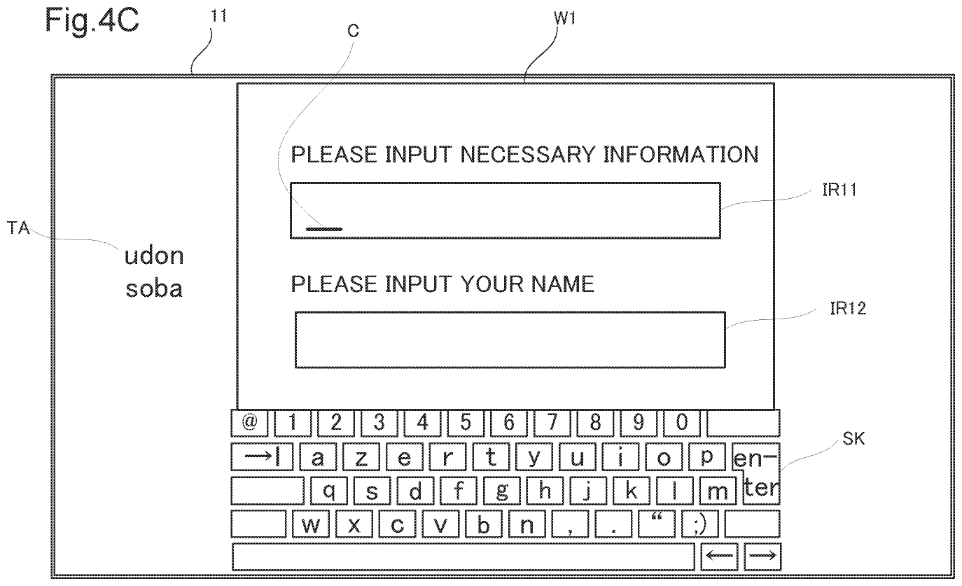

It will be assumed that a window W1 including input fields IR11 and IR12, for example as shown in FIG. 4A, are displayed in the screen of the display unit 11, under the control of the controller 21 (S101). The input fields IR11 and IR12 in the window W1 shown in FIG. 4A are to be used to input information and a name, respectively. In the region outside the window W1, character strings TA are displayed under the control of the controller 21.

With the window W1 displayed as above in the screen of the display unit 11, the controller 21 stands by for a touch operation of the user on the screen of the display unit 11. Upon detecting, through the touch panel 12, a touch operation performed on the screen of the display unit 11, the controller 21 decides, on the basis of the touched position, whether the touch operation has been performed on the blank portion in one of the input fields IR11 and IR12 (S102).

For example, when the user touches the blank portion in the input field IR11 (where no character is displayed) as shown in FIG. 4B, the controller 21 detects the touch operation on the blank portion of the input field IR11, through the touch panel 12 (Yes at S102), and puts the focus on the input field IR11. Then the controller 21 displays a cursor C in the input field IR11 as the example shown in FIG. 4C (S103), and displays the software keyboard SK, retrieved from the storage device 18, in the screen of the display unit 11 (S104). At this point, the controller 21 may enlarge the window W1 to a vacant space in the screen of the display unit 11 (not occupied yet with the window W1), and display the software keyboard SK in the vacant space.

With the software keyboard SK displayed as above, the controller 21 stands by for a touch operation of the user on the screen of the display unit 11. Upon detecting, through the touch panel 12, a touch operation performed on the screen of the display unit 11, the controller 21 decides, on the basis of the touched position, on which of (i) a key of the software keyboard SK, (ii) a character string displayed in the input field IR11 or IR12, (iii) a character string displayed in a region of the screen of the display unit 11 other than the input fields IR11 and IR12, or (iv) a non-display region in the screen of the display unit 11 where no character, symbol, or code is displayed, except the input fields IR11 and IR12, the touch operation has been performed (S105).

For example, when the user touches the key of the software keyboard SK, the controller 21 detects the touch operation on that key through the touch panel 12 (“Key” at S105), and inputs the character, symbol, or code associated with the touched key to the position of the cursor C in the input field IR11, focused at S103, to display the character, symbol, or code at the position of the cursor C (S106). Then the decider 22 decides whether the character string composed of the character, symbol, or code in the input field IR11 satisfies one of the aforementioned conditions (S107).

When the decider 22 decides that the character string in the input field IR11 does not satisfy any of the mentioned conditions (No at S107), the operation returns to S105.

When the decider 22 decides that the character string in the input field IR11 satisfies one of the mentioned conditions (Yes at S107), the controller 21 decides that the inputting of the character string to the input field IR11 has been finished (S108).

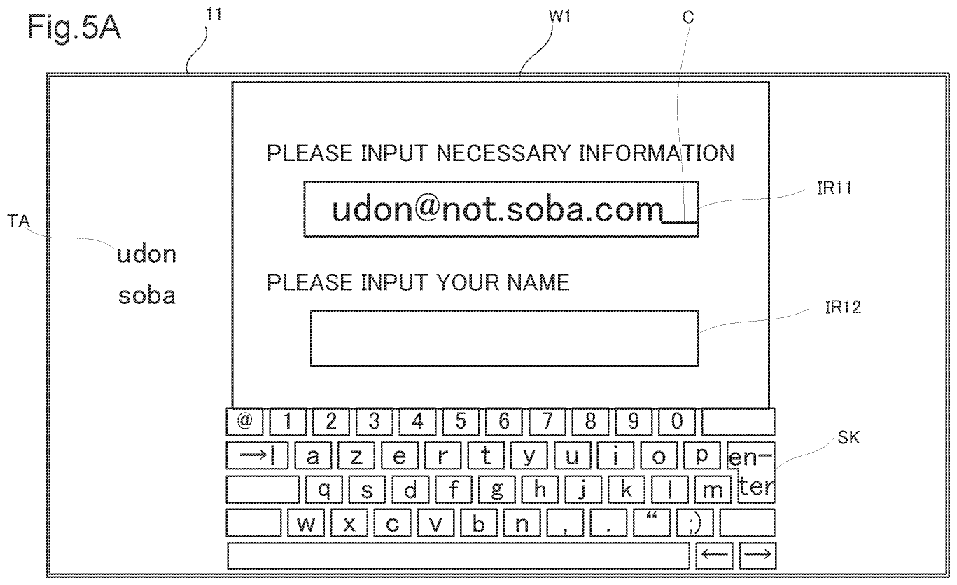

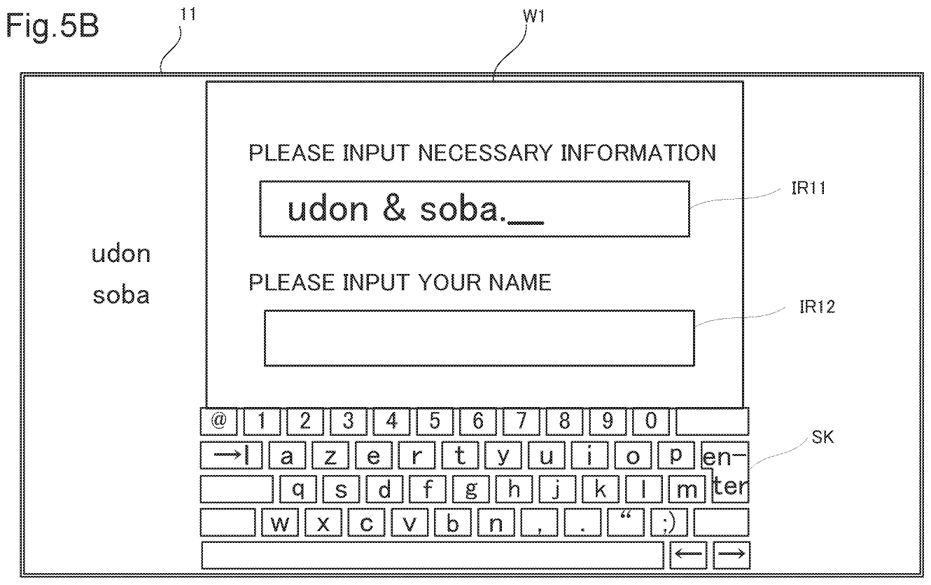

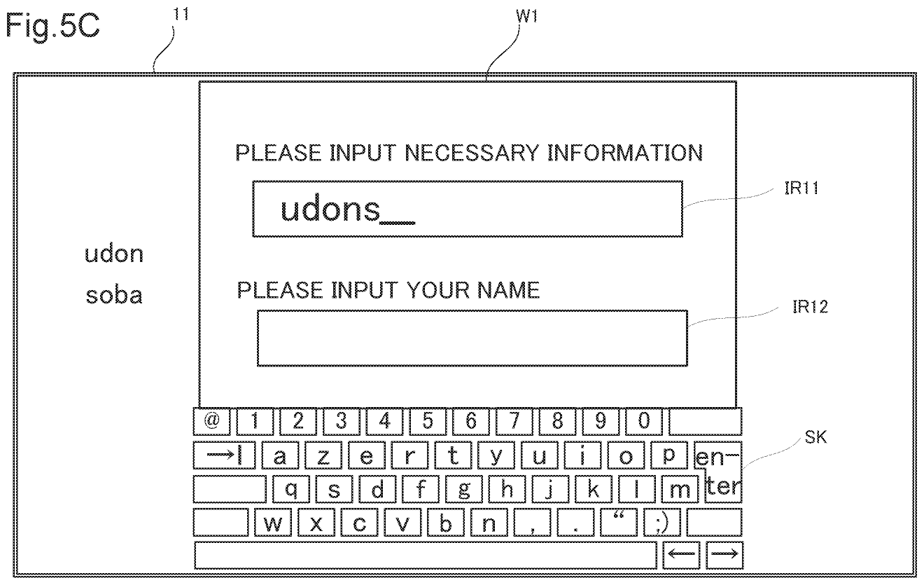

For example, when the decider 22 decides that the condition that, as shown in FIG. 5A, the characters, symbols, or codes located at the tail end, or along a plurality of positions from the tail end, of the character string in the input field IR11, accord with one of predetermined characters, symbols, or codes included in address information on the internet and indicating the tail end of the address information, such as “.com”, and “.co.jp”, has been satisfied (Yes at S107), the controller 21 decides that the inputting of the character string to the input field IR11 has been finished (S108).

Otherwise, when the decider 22 decides that the condition that, as shown in FIG. 5B, the code at the tail end of the character string in the input field IR11 is a punctuation mark such as “.”, has been satisfied (Yes at S107), the controller 21 decides that the inputting of the character string to the input field IR11 has been finished (S108).

Further, when the decider 22 decides that the condition that, as shown in FIG. 5C, the number of characters, symbols, or codes in the character string in the input field IR11 has reached the predetermined limiting number N (e.g., N=5), has been satisfied (Yes at S107), the controller 21 decides that the inputting of the character string to the input field IR11 has been finished (S108). Here, when the character string inputted to the input field IR11 represents a password or ID information, the controller 21 may decide that the inputting of the character string has been finished, when the number of characters, symbols, or codes representing the password or ID information accords with the limiting number N, and the password or ID information has been successfully authenticated. When the guidance of “Please Input Necessary Information” displayed above the input field IR11 shown in FIG. 5C is stated as “Please Input Password” or “Please Input ID Information”, the controller 21 may recognize beforehand that the password or ID information is to be inputted in the input field IR11.

When the user touches, while the software keyboard SK is displayed, the non-display region in the screen of the display unit 11 outside the input fields IR11 and IR12, where no character, symbol, or code is displayed, the controller 21 detects the touch operation on the non-display region, through the touch panel 12 (“Non-display Region” at S105), and decides that at this point the inputting of the character string to the input field IR11 has been finished (S108).

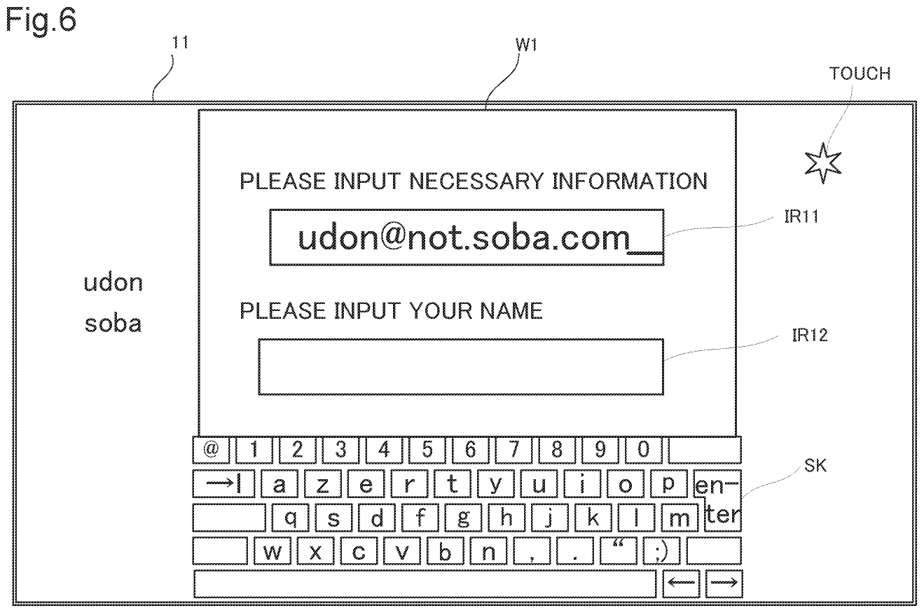

For example, when a touch operation is detected on the non-display region in the screen of the display unit 11 outside the input fields IR11 and IR12, where no character, symbol, or code is displayed, as shown in FIG. 6 (“Non-display Region” at S105), the controller 21 decides that the inputting of the character string to the input field IR11 has been finished (S108), despite the character string in the input field IR11 not satisfying any of the aforementioned conditions.

When the user touches the character string displayed in the input field IR11, while the software keyboard SK is displayed, the controller 21 detects the touched position in the character string, through the touch panel 12 (“Character String” at S105), and moves the cursor C to the detected position in the input field IR11 (S109).

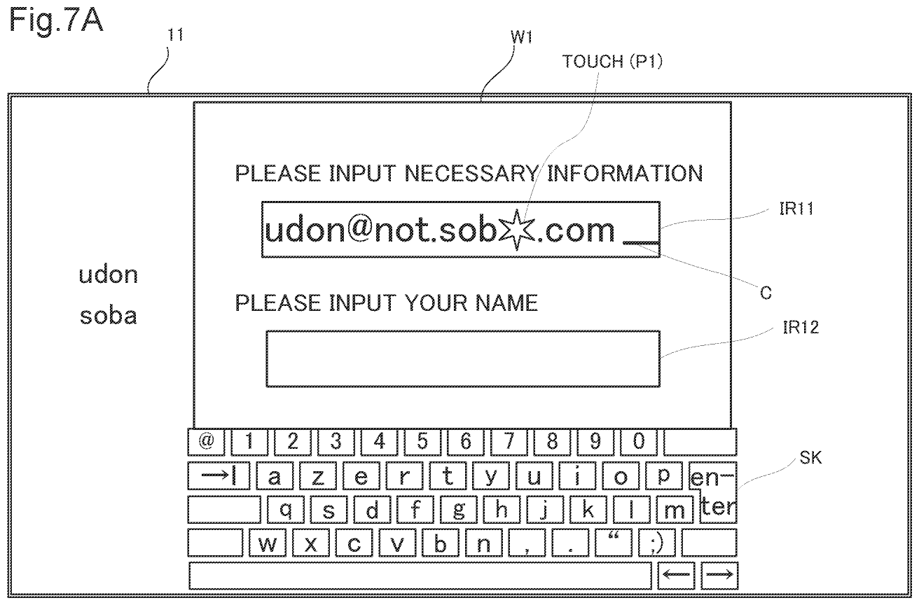

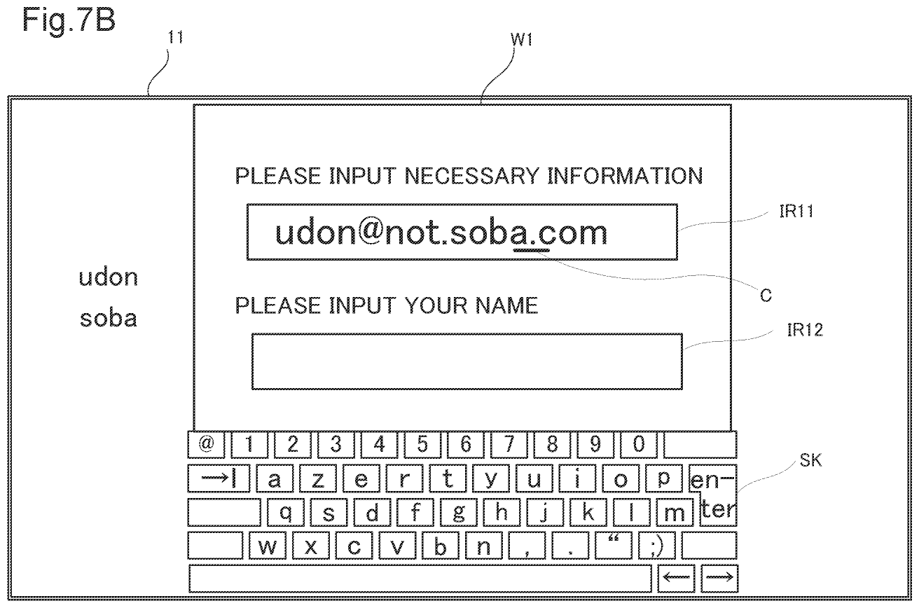

For example, when a touched position P1 is detected in the character string in the input field IR11 as shown in FIG. 7A (“Character String” at S105), the controller 21 moves the cursor C to the position P1 that has been detected, in the input field IR11, as shown in FIG. 7B (S109). Thereafter, the operation returns to S105.

Further, when the user keeps touching, while the software keyboard SK is displayed, the character string displayed in a region other than the input fields IR11 and IR12 in the screen of the display unit 11 for a predetermined period of time at S105, and the controller 21 detects the touch operation continued for the predetermined period of time, through the touch panel 12 (“Copy” at S105), the controller 21 saves the character string displayed at the touched position (S110). When the user touches the input field IR11 thereafter, the controller 21 detects the touched position in the input field IR11, through the touch panel 12 (S111), and displays the character string saved at S110, at the detected position in the input field IR11 (S112).

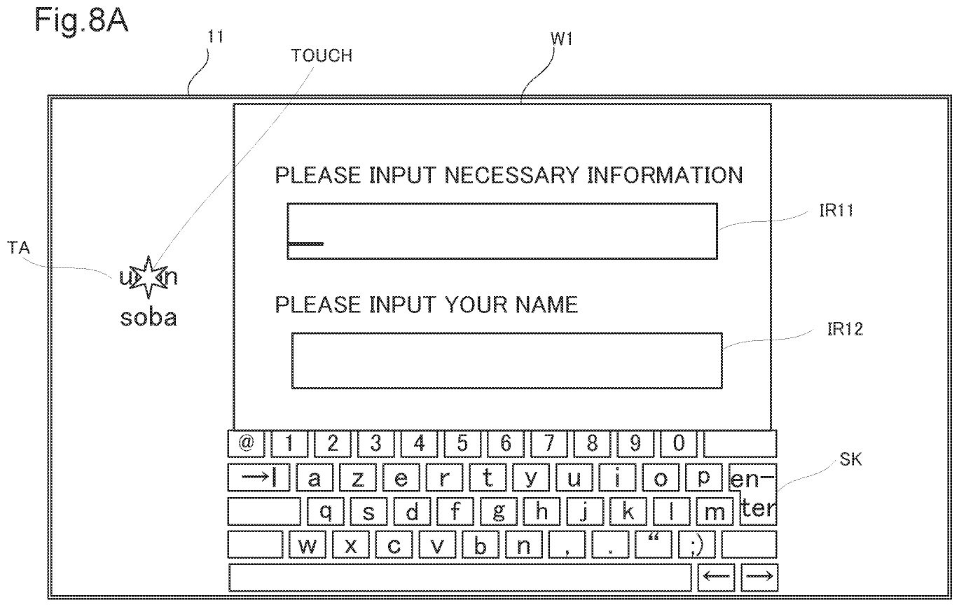

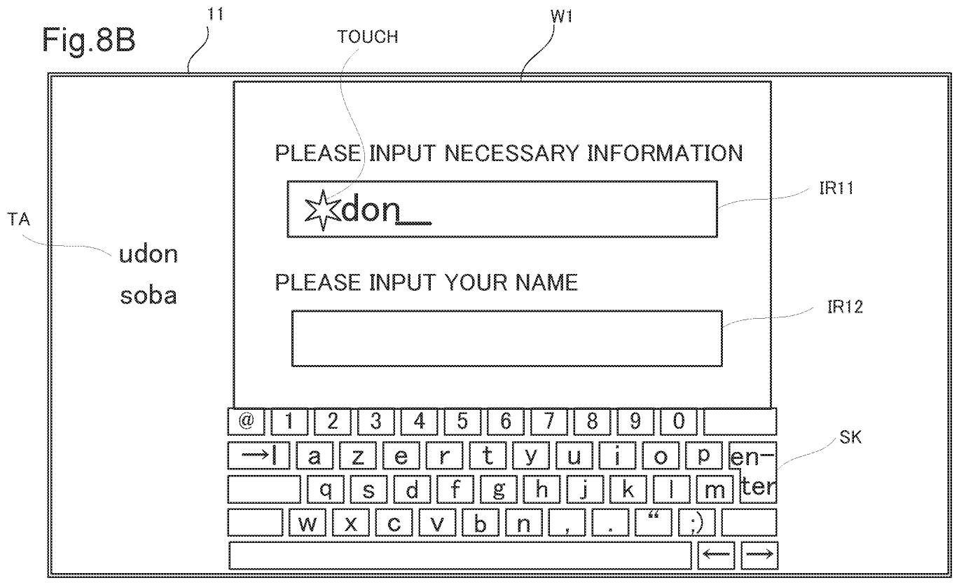

For example, upon detecting a touch operation continued for the predetermined period of time, on the character string TA in the region in the screen of the display unit 11 outside the input fields IR11 and IR12 as shown in FIG. 8A (“Copy” at S105), the controller 21 saves the touched character string (S110). Thereafter, when the touched position in the input field IR11 is detected (S111), the controller 21 displays the character string TA at the detected position in the input field IR11, as shown in FIG. 8B (S112).

Thereafter, the operation returns to S105. For example, upon detecting through the touch panel 12 that a key of the software keyboard SK has been touched (“Key” at S105), the controller 21 displays the character, symbol, or code associated with the touched key as an addition to the character string TA displayed in the input field IR11 (S106), and decides whether the character string in the input field IR11 satisfies any of the aforementioned conditions (S107). Then the controller 21 repeats a series of operations including returning to S105 upon deciding that none of the conditions is satisfied (No at S107), and finishing the inputting of the character string to the input field IR11 (S108), upon deciding that one of the conditions is satisfied (Yes at S107).

Then the controller 21 decides, after deciding that the inputting of the character string to the input field IR11 has been finished (S108), whether there is another input field in which no character string has been inputted yet (S113).

Upon deciding that there is another input field in which no character string has been inputted yet (Yes at S113), the controller 21 puts the focus on such input field, and displays the cursor C in the input field (input field IR12, in the example of FIG. 8B) (S114), with the software keyboard SK kept displayed. Then the operation returns to S105, and the operation from S105 to S113 is repeated, to input the character string in the input field, in which no character string has been inputted yet.

When the inputting of the character string is finished in all the input fields displayed, and the controller 21 decides that there is no input field in which no character string has been inputted (No at S113), the controller 21 erases the display of the software keyboard SK, from the screen of the display unit 11 (S115). Thereafter, the operation is finished.

The controller 21 acquires the character strings respectively displayed in the input fields IR11 and IR12, upon setting the software keyboard SK undisplayed as described above, and proceeds to predetermined processings to be performed on the basis of the character strings in the input fields IR11 and IR12 that have been acquired.

According to the foregoing embodiment, as described above, when the user touches the blank portion in the input field (where no character is displayed in the input field) displayed in the screen of the display unit 11, the software keyboard is displayed in the screen of the display unit 11. Then the software keyboard is erased (set to be undisplayed) from the screen of the display unit 11, when the character string in the input field satisfies one of the predetermined conditions. In the case where a plurality of input fields are displayed in the screen of the display unit 11, the software keyboard continues to be displayed, until the inputting in all the input fields is finished. Such an arrangement enables the software keyboard to be properly displayed and erased, so as to allow the user to handle the device more easily, thereby improving the user-friendliness of the software keyboard.

Although the display device is exemplified by the mobile terminal device 10 in the foregoing embodiment, the display device according to the present invention is broadly applicable to other types of electronic devices.

The display method according to the embodiment may be provided as a display control program stored in the ROM or the storage device 18. The display control program may be recorded on a computer-readable, non-transitory recording medium, such as a hard disk, a CD-ROM, a DVD-ROM, or a semiconductor memory. In this case, the computer-readable, non-transitory recording medium, containing the display control program recorded thereon, constitutes an embodiment of the present invention.

Further, the configurations and processings described in the foregoing embodiments with reference to FIG. 1 to FIG. 8B are merely exemplary, and in no way intended to limit the present invention to those configurations and processings.

1. A display device comprising:
a display unit;
a controller that displays an input field and a software keyboard on a screen of the display unit;
an input device that receives an input of a character string including a character, symbol, or code, to the input field, according to an operation performed by a user on the software keyboard; and
a decider that decides whether the character string inputted to the input field through the input device satisfies a predetermined condition,
wherein the controller sets the software keyboard undisplayed in the screen of the display unit, when the decider decides that the predetermined condition is satisfied.

2. The display device according to claim 1,
wherein the controller adopts, as the predetermined condition, a state where the character, symbol, or code located at a tail end, or along a plurality of positions from the tail end, of the character string inputted to the input field through the input device, accords with one of predetermined characters, symbols, or codes included in address information on the internet and indicating the tail end of the address information, and sets the software keyboard undisplayed in the screen of the display unit, when the decider decides that the condition is satisfied.

3. The display device according to claim 1,
wherein the controller adopts, as the predetermined condition, a state where the code at a tail end of the character string inputted to the input field through the input device is a punctuation mark, and sets the software keyboard undisplayed in the screen of the display unit, when the decider decides that the condition is satisfied.

4. The display device according to claim 1,
wherein the controller adopts, as the predetermined condition, a state where a number of characters, symbols, or codes in the character string inputted to the input field through the input device has reached a predetermined limiting number, and sets the software keyboard undisplayed in the screen of the display unit, when the decider decides that the condition is satisfied.

5. The display device according to claim 1, further comprising, as the input device, a touch panel overlaid on the screen of the display unit,
wherein the controller causes the display unit to display the software keyboard on the screen, upon detecting through the touch panel a touch operation on a blank portion in the input field in the screen of the display unit, and sets the software keyboard undisplayed in the screen of the display unit, upon detecting through the touch panel a touch operation on a non-display region in the screen of the display unit, outside the input field and where no character, symbol, or code is displayed.

6. The display device according to claim 5,
wherein, when a plurality of input fields and the software keyboard are displayed in the screen of the display unit, the controller keeps the software keyboard displayed until inputting in all of the input fields is finished through the input device.

7. The display device according to claim 5,
wherein, upon detecting through the touch panel a touch operation on the character string displayed in the input field in the screen of the display unit, the controller moves a cursor so as to display the cursor at a position on the character string that has been touched, and inputs, upon detecting through the touch panel an operation performed by the user on the software keyboard, the character, symbol, or code corresponding to the operation on the software keyboard to the position of the cursor, to display the character, symbol, or code at the position of the cursor.

8. The display device according to claim 5,
wherein, upon detecting through the touch panel a touch operation on a character string in a region in the screen of the display unit other than the input field, the controller copies the character string, and pastes, upon detecting through the touch panel a touch operation on the input field, the copied character string to the input field.

9. The display device according to claim 1,
wherein the controller adopts, as the predetermined condition, a state where a number of characters, symbols, or codes in the character string representing a password or ID information, inputted to the input field through the input device, accords with a predetermined limiting number, and that the password or the ID information has been authenticated, and sets the software keyboard undisplayed in the screen of the display unit, when the decider decides that the condition is satisfied.

10. A display control program configured to cause a computer to act as:
a controller that displays an input field and a software keyboard on a screen of a display unit;
an input device that receives an input of a character string including character, symbol, or code to the input field, according to an operation performed by a user on the software keyboard; and
a decider that decides whether the character string inputted to the input field through the input device satisfies a predetermined condition,
the display control program being further configured to cause the computer to cause the controller to set the software keyboard undisplayed in the screen of the display unit, when the decider decides that the predetermined condition is satisfied.
